(19) United States
(12) Patent Application Publication
(10) Pub. No.: US 2022/0074362 A1
(43) Pub. Date: Mar. 10, 2022

(54) METHOD FOR CONTROLLING EXHAUST AFTERTREATMENT SYSTEM FOR VEHICLE ENGINE

(71) Applicants: HYUNDAI MOTOR COMPANY, Seoul (KR); KIA MOTORS CORPORATION, Seoul (KR)

(72) Inventors: Ji Ho Cho, Seongnam-si (KR); Sung Mu Choi, Seongnam-si (KR)

(21) Appl. No.: 17/167,612

(22) Filed: Feb. 4, 2021

(30) Foreign Application Priority Data
Sep. 10, 2020 (KR) 10-2020-0116086

(51) Int. Cl. F02D 41/02; F02D 41/14; F01N 11/00

(52) U.S. Cl. CPC F02D 41/024; F02D 41/1445; F02D 41/1446; F01N 2550/02; F01N 11/002; F01N 2560/06; F02D 41/1454

(57) ABSTRACT

A method for controlling an exhaust aftertreatment system for a vehicle includes: determining, by a controller, whether or not a driving state of the vehicle satisfies a clogging determination condition; estimating, by the controller, a normal temperature of a rear end of a catalytic converter upon determining that the clogging determination condition is satisfied; calculating, by the controller, clogging indexes using an actual temperature of the rear end of the catalytic converter measured by a temperature sensor and the estimated normal temperature; determining, by the controller, whether or not it is necessary to settle clogging of the catalytic converter by comparing the clogging indexes with reference ranges; and executing, by the controller, a clogging settlement mode upon determining that it is necessary to settle clogging of the catalytic converter.

### CROSS-REFERENCE TO RELATED APPLICATION

This application claims priority the benefit of Korean Patent Application No. 10-2020-0116086, filed on Sep. 10, 2020, in the Korean Intellectual Property Office, the disclosure of which is incorporated herein by reference in its entirety.

### TECHNICAL FIELD

The present disclosure relates to a method for controlling an exhaust aftertreatment system for a vehicle engine, and more particularly, to a technology which controls a catalyst apparatus installed in a vehicle in order to purify exhaust gas emitted from the engine of the vehicle.

### TECHNICAL FIELD

In direct injection engines, such as a gasoline direct injection (GDI) engine and a common rail direct injection (CRDI) engine, the frequency of occurrence of a local fuel-enriched area in a combustion chamber is high under a high-load driving condition (an excessive fuel driving condition), and in this case, the emission amount of particulate matter rapidly increases.

Most of the above-emitted particulate matter passes through a channel flow-type catalytic converter, such as a three way catalyst (TWC), a diesel oxidation catalyst (DOC) and a lean NOₓ trap (LNT), and is collected in and removed by a particulate filter, such as a gasoline particulate filter (GPF) or a diesel particulate filter (EPF).

However, among particulate matter, high-viscosity particulate matter, which is combined with hydrocarbons having multiple bonding and thus has a high viscosity, does not pass through the channel flow-type catalytic converter, thereby being capable of clogging the channel flow-type catalytic converter, i.e., a catalyst.

Such clogging of the catalyst may be settled by exposing the clogged catalyst to a high temperature of 500° C., however, when clogging of the catalyst is not settled at an appropriate time, quality problems, such as an increase in the emission amount of contaminants, engine stall, excessive heating of the catalytic converter, etc., may be encountered.

The above information disclosed in the Background section is only for enhancement of understanding of the background of the disclosure and should not be interpreted as conventional technology that is already known to those skilled in the art.

### SUMMARY

The present disclosure has been made in view of the above problems, and it is an object of the present disclosure to provide a method for controlling an exhaust aftertreatment system for vehicle engines, in which clogging of a channel flow-type catalytic converter provided to purify exhaust gas from an engine is detected and controlled such that the degree of clogging of the catalytic converter does not exceed a designated level, and thus, stability in performance to purify toxic substances in the exhaust gas may be improved so as to satisfy various regulations and to reduce environmental contamination.

In accordance with an aspect of the present disclosure, the above and other objects can be accomplished by the provision of a method for controlling an exhaust aftertreatment system for an engine vehicle, the method including: determining, by a controller, whether or not a driving state of the vehicle satisfies a clogging determination condition; estimating, by the controller, a normal temperature of a rear end of a catalytic converter upon determining the clogging determination condition is satisfied; calculating, by the controller, clogging indexes using an actual temperature of the rear end of the catalytic converter measured by a temperature sensor and the estimated normal temperature; determining, by the controller, whether or not it is necessary to settle clogging of the catalytic converter by comparing the clogging indexes with reference ranges; and executing, by the controller, a clogging settlement mode upon determining that it is necessary to settle clogging of the catalytic converter.

In the determining whether or not the driving state of the vehicle satisfies the clogging determination condition, at least one of a flow velocity of exhaust gas from the engine, a temperature of an inlet of the catalytic converter, or an air-fuel ratio may be determined.

The clogging indexes may include slopes of linear regression lines of the actually measured temperature and the estimated normal temperature of the rear end of the catalytic converter over time, and squares of Pearson's product moment correlation coefficients of the actually measured temperature and the estimated normal temperature of the rear end of the catalytic converter over time.

The clogging indexes may include slopes of linear regression lines of the actually measured temperature and the estimated normal temperature of the rear end of the catalytic converter over time.

The clogging indexes may include squares of Pearson's product moment correlation coefficients of the actually measured temperature and the estimated normal temperature of the rear end of the catalytic converter over time.

When any one of the slopes and the squares of the Pearson's product moment correlation coefficients deviates from the corresponding one of the reference ranges, it may be determined that it is necessary to settle clogging of the catalytic converter.

Each of the reference ranges may be set by an upper limit value and a lower limit value based on 1.

In the clogging settlement mode, the engine may be driven such that a temperature of the catalytic converter reaches a designated settlement temperature or higher, and a duration of the clogging settlement mode may be set to be elongated in proportion to degrees of deviation of the clogging indexes from the reference ranges.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a view exemplarily illustrating a vehicle engine and an exhaust aftertreatment system for vehicle engines, to which the present disclosure is applicable;

FIG. 2 is a flowchart illustrating a method for controlling the exhaust aftertreatment system for engine vehicles according to the present disclosure;

FIG. 3 is a view illustrating modeling of the first law of thermodynamics with regard to a catalytic converter;

FIG. 4 is a view illustrating a void fraction used in modeling of FIG. 3;

FIGS. 5 to 7 are graphs conceptually illustrating three feasible cases in which a measured temperature and an estimated normal temperature are changed over time; and

FIG. 8 shows graphs illustrating the temperature of the outlet of the catalytic converter, slopes, and R2s of a normal catalyst, a catalyst which is clogged by 40% and a catalyst which is clogged by 50% depending on the passage of time.

### DETAILED DESCRIPTION

Reference will now be made in detail to the exemplary embodiments of the present disclosure, examples of which are illustrated in the accompanying drawings. Wherever possible, the same reference numbers will be used throughout the drawings to refer to the same or like parts.

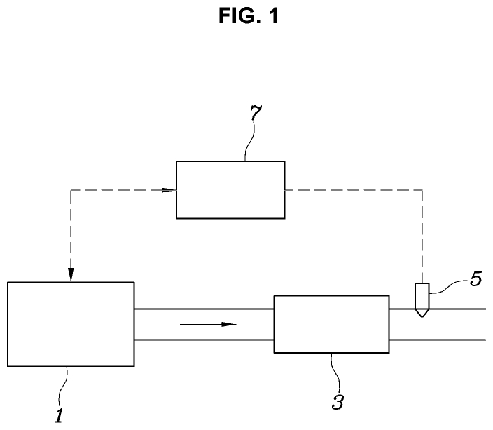

FIG. 1 is a view exemplarily illustrating a vehicle engine 1 and an exhaust aftertreatment system for vehicle engines, to which the present disclosure is applicable. Exhaust gas from the engine 1 is purified by a catalytic converter 3 and then emitted, a temperature sensor 5 installed at the rear end of (downstream from) the catalytic converter 3 measures the temperature of the rear end of the catalytic converter 3 and transmits information about the measured temperature to a controller 7, and the controller 7 is configured to calculate clogging indexes, which will be described below, using the measured temperature of the rear end of the catalytic converter 3 received through a signal from the temperature sensor 5 and to drive the engine 1 in a clogging settlement mode, which will be described below.

Here, the catalytic converter 3 means the above-described channel flow-type catalytic converter, and a particulate filter, such as a gasoline particulate filter (GPF) or a diesel particulate filter (EPF), may be installed downstream from the catalytic converter 3.

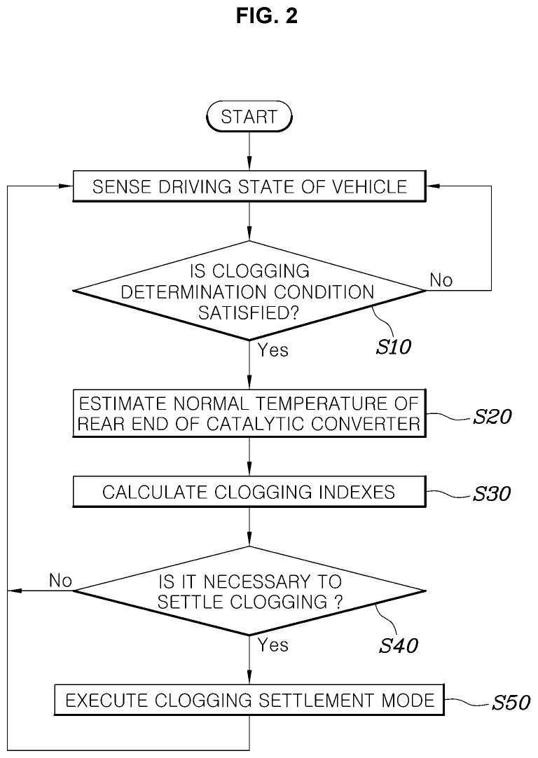

Referring to FIG. 2, a method for controlling the exhaust aftertreatment system for engine vehicles according to the present disclosure includes determining, by the controller 7, whether or not the driving state of the vehicle satisfies a designated clogging determination condition (S10), estimating, by the controller 7, the normal temperature of the rear end of the catalytic converter 3 when the clogging determination condition is satisfied (S20), calculating, by the controller 7, designated clogging indexes using the temperature of the rear end of the catalytic converter 3 actually measured by the temperature sensor 5 and the estimated normal temperature (S30), determining, by the controller 7, whether or not it is necessary to settle clogging of the catalytic converter 3 by comparing the clogging indexes with designated reference ranges (S40), and executing, by the controller 7, a designated clogging settlement mode upon determining that it is necessary to settle clogging of the catalytic converter 3 (S50).

That is, when the driving state of the vehicle satisfies the clogging determination condition, the controller 7 calculates the clogging indexes using the actually measured temperature acquired by measuring the temperature of the rear end of the catalytic converter 3 and the normal temperature acquired by estimation, and determines whether or not the clogging settlement mode of the catalytic converter 3 is executed by comparing the clogging indexes with the reference ranges, thereby being capable of consistently maintaining and securing a smooth flow state in the catalytic converter 3 through proper execution of the clogging settlement mode before the catalytic converter 3 is excessively clogged, and thus providing stabilized purification performance.

In determining whether or not the driving state of the vehicle satisfies the clogging determination condition, at least one of the flow velocity of the exhaust gas from the engine 1, the temperature of the inlet of the catalytic converter 3, or an air-fuel ratio is determined.

That is, physical quantities, indicating the driving state of the vehicle used when the controller 7 determines whether or not the clogging determination condition is satisfied, include one or more of the flow velocity of the exhaust gas from the engine 1, the temperature of the inlet of the catalytic converter 3, and the air-fuel ratio.

For example, with regard to the flow velocity of the exhaust gas from the engine 1, when the controller 7 calculates the clogging indexes and determines whether or not it is necessary to settle clogging of the catalytic converter 3 by comparing the clogging indexes with the reference ranges, the controller 7 determines the range of the flow velocity of the exhaust gas to determine whether or not it is necessary to settle clogging of the catalytic converter 3 at accuracy of a desired level or higher by a large number of experiments and analyses, stores the determined range of the flow velocity of the exhaust gas, and when the flow velocity of the exhaust gas from the engine 1 depending on the driving state of the vehicle belongs to the stored range of the flow velocity, determines that at least a portion of the clogging determination condition is satisfied.

In case of the temperature of the inlet of the catalytic converter 3 or the air-fuel ratio, the range of the temperature of the inlet of the catalytic converter 3 or the range of the air-fuel ratio determined by a large number of experiments and analyses may be stored and then be used to determine whether or not the clogging determination condition is satisfied in the same manner.

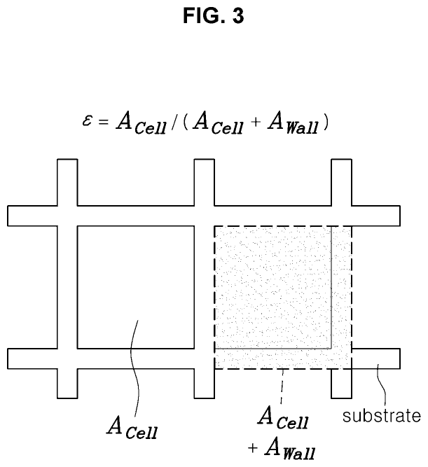

When the controller 7 estimate the normal temperature of the rear end of the catalytic converter 3, the controller 7 may use equations in which the catalytic converter 3 is modeled according to the first law of thermodynamics. That is, the first law of thermodynamics with respect to the catalytic converter 3, i.e., a target object to be controlled according to the present disclosure, may be modeled, as shown in FIG. 3, and equations for a substrate and exhaust gas shown in FIG. 3 may be modeled respectively as follows.

$${ɛρ}_{Gas} {c}_{p , Gas} \frac{\partial {T}_{Gas}}{\partial t} + \frac{G}{{A}_{Cell}} {c}_{p , Gas} \frac{\partial {T}_{Gas}}{\partial x} = \frac{\partial }{\partial x} ( ɛ {k}_{Gas} \frac{\partial {T}_{Gas}}{\partial x} ) - {h}_{Gas 2 Bed} {G}_{a} ( {T}_{Gas} - {T}_{Bed} )$$

$$( 1 - ɛ ) {ρ}_{Bed} {c}_{p , Bed} \frac{\partial {T}_{Bed}}{\partial t} = \frac{\partial }{\partial x} ( ( 1 - ɛ ) {k}_{Bed} \frac{\partial {T}_{Bed}}{\partial x} ) + {h}_{Gas 2 Bed} {G}_{a} ( {T}_{Gas} - {T}_{Bed} )$$

Here,

ε: void fraction,

ε=A_{cell}/(A_{cell}+A_{wall}),

ρ: density,

c_p: specific heat at constant pressure,

T: temperature,

G: mass flow,

A_{cell}: sectional area of substrate cell,

Gₐ: surface area/volume,

$${G}_{a} = \{ \begin{matrix}\frac{4 ɛ}{d} ( square \text{/} circular ) \\ \frac{2 ɛ}{bh} [ b + \sqrt{{b}^{2} + 4 {h}^{2}} ] ( triangle ) \\ \frac{2 ɛ ( b + h )}{bh} ( rectangular )\end{matrix}$$

b: base,

h: height,

h_{Gas2Bed}: heat transfer coefficient from exhaust gas to substrate,

$${h}_{Gas 2 Bed} = \frac{{k}_{Gas}}{{d}_{H}} {N}_{u} ,$$

k_{Gax}: conductivity

d_{H}: hydraulic diameter,

Nᵤ: Nusselt number,

here, in flow in turbulent flow pipe in forced convection,

Nᵤ=0.023Re^{4/s}Prⁿ,

n=0.4 for heating,

n=0.3 for cooling,

Pr=cₚμ/k,

$${c}_{p , Bed} = 1.05 \frac{kJ}{{kgK}^{′}}$$

### for Cordierite

c_{p,Gas}=a₂T²+a₁T+a₀, for air

here,

$${a}_{0} = 9.712142 E - 01 \frac{kJ}{kgK} , \\ {a}_{1} = 3.33761612 E - 04 \frac{kJ}{{kgk}^{2}} , \\ {a}_{2} = - 1.158235 E - 07 \frac{kJ}{{kgk}^{3}} ,$$

and

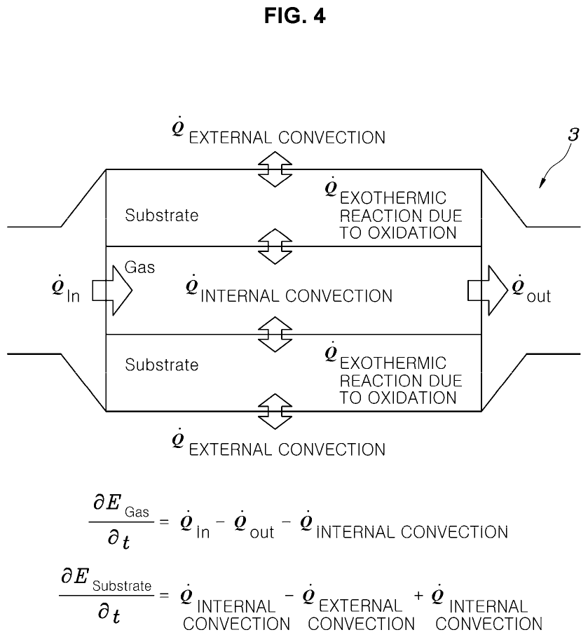

A_{cell} and A_{Wall} used in calculation of the void fraction ε are exemplarily illustrated in FIG. 4.

The temperature of the rear end of the catalytic converter 3 may be estimated in a manner of acquiring an inverse matrix by converting the above differential equations into Algebraic equations by discretization, and the estimated temperature is the temperature of the rear end of the catalytic converter 3 in a normal state, in which the catalytic converter 3 is not clogged, and will thus be referred to as a “normal temperature”.

In this embodiment, the clogging indexes include slopes, i.e., the slopes of linear regression lines of the actually measured temperature and the estimated normal temperature of the catalytic converter 3 over time, and the squares of Pearson's product moment correlation coefficients of the actually measured temperature and the estimated normal temperature of the catalytic converter 3 over time.

That is, in this embodiment, whether or not it is necessary to execute the clogging settlement mode of the corresponding catalytic converter 3 is determined by calculating the two clogging indexes, i.e., the slopes and the squares of Pearson's product moment correlation coefficients, and then simultaneously determining the two clogged indexes.

Only the slopes of linear regression lines of the actually measured temperature and the estimated normal temperature of the catalytic converter 3 over time may be used as the clogging index, or only the squares of the Pearson's product moment correlation coefficients of the actually measured temperature and the estimated normal temperature of the catalytic converter 3 over time may be used as the clogging index. However, in this embodiment, in order to realize more accurate determination, both the slopes and the squares of Pearson's product moment correlation coefficients are used as the clogging indexes.

The slope is expressed by the following equations.

$$Slope = \frac{n {Σ}_{i}^{n} {x}_{i} {y}_{i} - {Σ}_{i}^{n} {x}_{i} {Σ}_{i}^{n} y}{n {Σ}_{i}^{n} {x}_{i} - {( {Σ}_{i}^{n} {x}_{i} )}^{2}}$$

Here, i=1, 2, 3, . . . , n−1, n,

n indicates the total number of data (x, y) used in calculation of the slope, and one of x and y indicates the actually measured temperature, and the other of x and y indicates the estimated normal temperature.

Further, the square of the Pearson's product moment correlation coefficient is expressed by the following equations.

$${R}_{2} = {( \frac{n {Σ}_{i}^{n} {x}_{i} {y}_{i} - {Σ}_{i}^{n} {x}_{i} {Σ}_{i}^{n} y}{\sqrt{n {Σ}_{i}^{n} {x}_{i} - {( {Σ}_{i}^{n} {x}_{i} )}^{2}} \sqrt{n {Σ}_{i}^{n} {y}_{i} - {( {Σ}_{i}^{n} {y}_{i} )}^{2}}} )}^{2}$$

Here, i=1, 2, 3, . . . , n−1,

n, n indicates the total number of data (x, y) used in calculation of the square of the Pearson's product moment correlation coefficient, and one of x and y indicates the actually measured temperature, and the other of x and y indicates the estimated normal temperature.

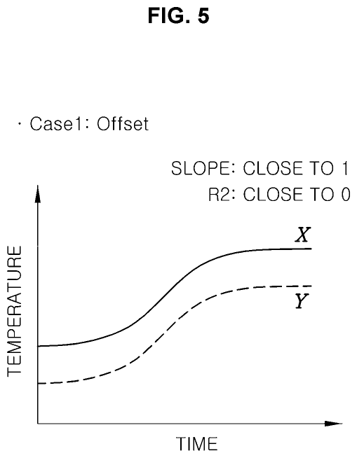

FIGS. 5 to 7 are graphs conceptually illustrating three feasible cases, when the actually measured temperature and the estimated normal temperature of the rear end of the catalytic converter 3 are compared, as described above.

In case 1 shown in FIG. 5, a difference between the actually measured temperature and the estimated normal temperature remains constant over time (offset), and in this case, the slopes of these temperatures are close to 1 but the squares of the Pearson's product moment correlation coefficients of these temperatures (for convenience, the square of the Pearson's product moment correlation coefficient is referred to as ‘R2’) have values which are less than 1 but are close to 0. Therefore, this case is referred to as an offset state.

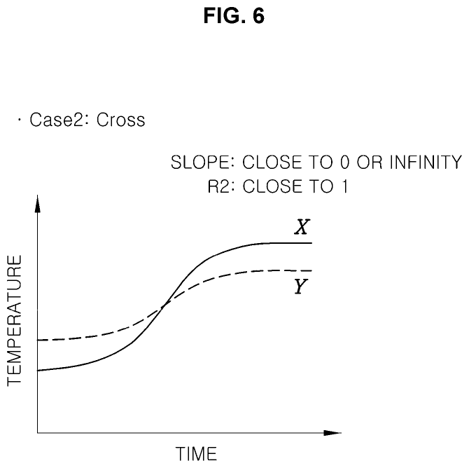

In case 2 shown in FIG. 6, a difference between the actually measured temperature and the estimated normal temperature is changed over time, and in contrast to case 1, the slopes of these temperatures have values which are less than 1 or greater than 1 and the R2s of these temperatures have values which are close to 1. This case is referred to as a cross state.

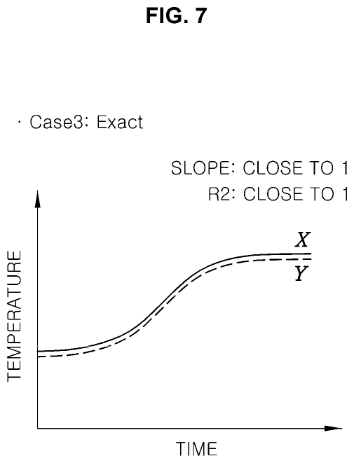

In case 3 shown in FIG. 7, the actually measured temperature and the estimated normal temperature coincide with each other and there is no difference therebetween, and in this case, both the slopes and the R2s of these temperatures have values which are close to 1. This case is referred to as an exact state.

Referring to the above three cases, when the two clogging indexes, i.e., both the slopes and the R2s of the actually measured temperature and the estimated normal temperature, have values close to 1, it may be considered that the catalytic converter 3 is not clogged and is thus in the normal state, and when any one of the two clogging indexes deviates from the specific reference range, it may be determined that the catalytic converter 3 is in a clogged state.

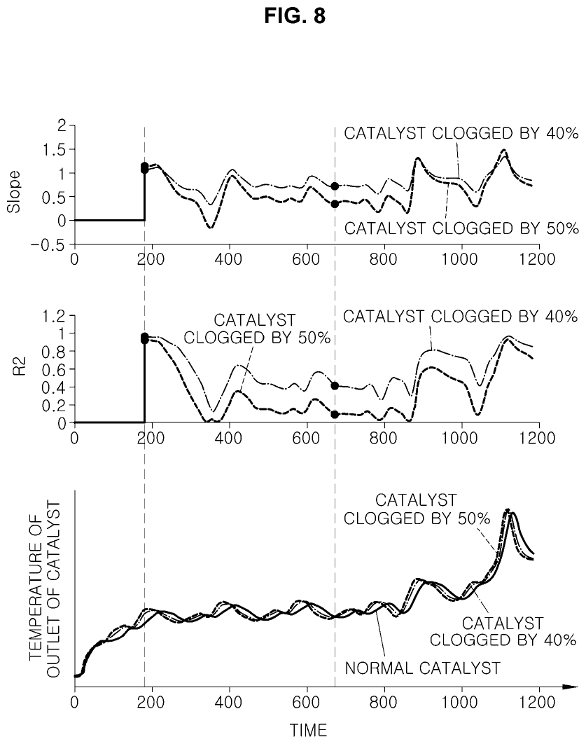

This will be confirmed through graphs shown in FIG. 8. That is, FIG. 8 shows graphs illustrating the temperatures of the outlets of a normal catalyst, a catalyst clogged by 40% and a catalyst clogged by 50%, the slopes thereof and the values of R2s of these catalysts depending on the passage of time, and it may be confirmed that the slope of the temperature of the catalyst clogged by 50% are farther away from 1 than the slopes of the temperatures of the catalyst clogged by 40% and the R2s of the temperatures of the catalyst clogged by 50% are farther away from 1 than the slopes of the temperatures of the catalyst clogged by 40%.

That is, the degree of clogging of the corresponding catalyst converter may be detected based on how far the slope and the R2 thereof are away from 1, as described above.

Therefore, in the present disclosure, when any one of the two clogging indexes, i.e., the slopes and the squares of the Pearson's product moment correlation coefficients of the temperatures of a catalytic converter deviates from the respective reference ranges, it is determined that it is necessary to settle clogging of the corresponding catalytic converter.

Here, the reference range is set by an upper limit value and a lower limit value based on 1.

For example, the reference range may be set to 0.5-1.5, and actually, the reference range may be suitably set through a plurality of experiments using a catalytic converter to which the present disclosure is to be applied.

In the clogging settlement mode, the engine 1 is driven such that the temperature of the catalytic converter 3 reaches a designated settlement temperature or higher, and the duration of the clogging settlement mode may be set to be elongated in proportion to a degree of deviation of the clogging index from the reference range.

That is, the controller 7 controls the engine 1 such that the catalytic converter 3 is heated to the settlement temperature or higher, thereby being capable of removing high-viscosity particulate matter, causing clogging of the catalytic converter 3, through combustion.

Therefore, the settlement temperature may be set to a temperature sufficient to combust matter causing clogging of the catalytic converter 3, for example, 500° C.

Further, when the duration of the clogging settlement mode is elongated in proportion to the degree of deviation of the clogging index from the reference range, the duration is increased as the determined degree of clogging of the catalytic converter is increased, and thus, clogging of the catalytic converter may be appropriately settled.

As is apparent from the above description, in a method for controlling an exhaust aftertreatment system for vehicle engines according to the present disclosure, clogging of a channel flow-type catalytic converter provided to purify exhaust gas from an engine is detected and controlled such that the degree of clogging of the catalytic converter does not exceed a designated level, and thus, stability in performance to purify toxic substances in the exhaust gas may be improved so as to satisfy various regulations and to reduce environmental contamination.

Further, in the method according to the present disclosure, clogging of the catalytic converter may be monitored and removed at an appropriate time, thereby being capable of preventing fuel efficiency deterioration and output reduction due to an increase in the back pressure of the engine and preventing engine stall and excessive heating of the catalytic converter.

Although the exemplary embodiments of the present disclosure have been disclosed for illustrative purposes, those skilled in the art will appreciate that various modifications, additions and substitutions are possible, without departing from the scope and spirit of the disclosure as disclosed in the accompanying claims.

What is claimed is:

1. A method for controlling an exhaust aftertreatment system for a vehicle, the method comprising:
determining, by a controller, whether or not a driving state of the vehicle satisfies a clogging determination condition;
estimating, by the controller, a normal temperature of a rear end of a catalytic converter upon determining that the clogging determination condition is satisfied;
calculating, by the controller, clogging indexes using an actual temperature of the rear end of the catalytic converter measured by a temperature sensor and the estimated normal temperature;
determining, by the controller, whether or not it is necessary to settle clogging of the catalytic converter by comparing the clogging indexes with reference ranges; and
executing, by the controller, a clogging settlement mode upon determining that it is necessary to settle clogging of the catalytic converter.

2. The method according to claim 1, wherein the determining whether or not a driving state of the vehicle satisfies the clogging determination condition includes determining at least one of a flow velocity of exhaust gas from an engine, a temperature of an inlet of the catalytic converter, or an air-fuel ratio.

3. The method according to claim 1, wherein the clogging indexes comprise:
slopes of linear regression lines of the actual temperature and the estimated normal temperature of the rear end of the catalytic converter over time; and
squares of Pearson's product moment correlation coefficients of the actual temperature and the estimated normal temperature of the rear end of the catalytic converter over time.

4. The method according to claim 1, wherein the clogging indexes comprise slopes of linear regression lines of the actual temperature and the estimated normal temperature of the rear end of the catalytic converter over time.

5. The method according to claim 1, wherein the clogging indexes comprise squares of Pearson's product moment correlation coefficients of the actual temperature and the estimated normal temperature of the rear end of the catalytic converter over time.

6. The method according to claim 3, wherein the determining whether or not it is necessary to settle clogging of the catalytic converter includes, when any one of the slopes and the squares of the Pearson's product moment correlation coefficients deviates from the corresponding one of the reference ranges, determining that it is necessary to settle clogging of the catalytic converter.

7. The method according to claim 6, wherein each of the reference ranges is set by an upper limit value and a lower limit value based on 1.

8. The method according to claim 1, wherein, the executing clogging settlement mode includes driving an engine such that an overall temperature of the catalytic converter reaches a settlement temperature or higher, and
wherein a duration of the clogging settlement mode is set to be elongated in proportion to degrees of deviation of the clogging indexes from the reference ranges.
